(19) United States
(12) Patent Application Publication
(10) Pub. No.: US 2020/0148595 A1
(43) Pub. Date: May 14, 2020

(54) MULTIFUNCTIONAL COMPOSITE BUILDING MATERIALS AND CONSTRUCTION THEREOF

(71) Applicants: Byong Hyok RI, Pyongyang (KP); Kang Kwon RI, Pyongyang (KP); Dae Kwon RI, Pyongyang (KP)

(72) Inventors: Byong Hyok RI, Pyongyang (KP); Kang Kwon RI, Pyongyang (KP); Dae Kwon RI, Pyongyang (KP); Byong Rok RI, Haeju (KP)

(21) Appl. No.: 16/473,330

(22) PCT Filed: Dec. 28, 2016
(86) PCT No.: PCT/KP2016/000044

§ 371 Date: Jun. 25, 2019

(30) Foreign Application Priority Data
Dec. 26, 2016 (KP) 201620005052

(51) Int. Cl. C04B 30/00; C04B 24/16; C04B 24/08; C04B 24/38; E04B 1/64; E04B 1/66; E04B 1/74; E04B 1/94

(52) U.S. Cl. CPC C04B 30/00; C04B 24/16; C04B 24/085; C04B 24/383; C04B 2103/304; E04B 1/66; E04B 1/74; E04B 1/948; E04B 1/64

(57) ABSTRACT

Multifunctional composite building materials, which are obtained by mixing nano silicon dioxide, nano titanium dioxide, nano aluminum oxide and nano zinc oxide with nano nickel-cobalt ferrite or nano nickel-zinc ferrite; surface active agent; air entrained agent such as diethanolamine lauryl sulphonate, protein extracts, pulp waste liquid, diatomite; “kumgang” medical stone; viscosifier such as hydroxyl ethyl cellulose and foam elimination agent such as tributylphosphoric acid ester or butanol in a certain ratio.

### BACKGROUND AND PURPOSE OF INVENTION

Now, building structures including house, public buildings, underground structures, freezing facilities, tunnel, canal tunnel, roadway tunnel or road facilities network, after completing concrete structure work (construction of foundation wall and framing of buildings), are completed through various construction processes such as waterproofing process, dump-proofing process, adhering of heat insulating materials or expanded plastics, installation of wire mesh or galvanized fabric, dilatation, fixing of dead bolt, secondary plastering, putty plastering, abrasive process, coating with primer for indoor paint or outdoor paint, and so on. This requires a great deal of materials, fund, labor and time.

With the development of green architectural technology and energy efficient technology and improvement of the material and cultural living standard of people, the needs for zero-energy, zero-carbon structures increase and it requires to raise the life and quality of buildings as well as reducing the time and costs by single-constructing in place of various construction processes such as adhesion of heat preservation, waterproofing, dump-proofing and fire prevention materials.

Worldwide, researches to overcome defects of building materials having one function such as heat preservation or heat insulation and to develop building materials with various functions have been made.

CN 104591681 disclosed an inorganic efficient waterproof adiabatic building materials and use thereof. The materials have the advantages of low heat conductivity coefficient, tensile strength of less than 400 kpa, high compressive strength, fireproof property, non-combustion, waterproof and water-repellent functions and are applicable to coating for heat-preservation, adiabatic and waterproof of building walls, basements and roof and the above materials are used directly after being mixed with water.

CN101172817 disclosed architecture material based on waterproof, heat insulating, heat preserving and antifreezing roof and wall, and uses thereof.

The building materials according to CN101172817 are obtained by mixing cement, putty powder, light calcium powder, granulating slag, quartz, pearlife, vitreous micro bead, anticlastic fibre, lumber ash, polyvinyl alcohol, lustre-coating agent and clean water in a certain ratio. CN101172817 further disclosed the method of using the waterproof adiabatic insulated freezeproof roofing and wall which are prepared by the above materials.

The purpose of the present invention is to provide multifunctional composite building materials with various functions such as heat preservation, freezing preservation, heat insulation, waterproofing, damp-proofing, fire prevention, exfoliation prevention, sound insulation, blooming prevention, air purifying, sterilization and anion generating.

The purpose is further to provide construction method of single coating the said multifunctional composite building materials in place of various construction processes already formularized in the process of building, thereby saving a lot of materials, cost and labor, and increasing construction speed, and prolonging the life of buildings over 3 times.

The purpose is further to provide construction method of directly spraying or coating the concrete or cement mortar plastered layer of the inside and outside of buildings with the mixture of the said multifunctional composite building materials and vehicle so that the layer has a thickness of not less than 0.5 mm.

### BRIEF DESCRIPTION OF INVENTION

The present invention relates to a multifunctional composite building materials with various functions such as heat preservation, freezing preservation, heat insulation, waterproofing, damp-proofing, fire prevention, exfoliation prevention, sound insulation, blooming prevention, air purifying, sterilization and anion generating.

The present invention provides the multifunctional composite building materials, which are obtained by mixing nano materials such as nano silicon dioxide, nano titanium dioxide, nano aluminum oxide and nano zinc oxide with nano nickel-cobalt ferrite or nano nickel-zinc ferrite; surface active agent; air entrained agent such as diethanolamine lauryl sulphonate, protein extracts, pulp waste liquid, diatomite; “Kumgang” medical stone; viscosifier such as hydroxy ethyl cellulose (HEC) and foam elimination agent such as tributylphosphoric acid ester or butanol in a certain ratio.

The present invention further provides a construction method of single coating the said multifunctional composite building materials in place of various construction processes already formularized in the process of building.

The present invention further provides the construction method of spraying or coating concrete or cement mortar plastered layer of the inside and outside of buildings with the mixture of the said multifunctional composite building materials and vehicle to form nano membrane having a thickness of not less than 0.5 mm, thereby making the surface of concrete or cement mortar layer as one layer which is full of nano-micropores and has multi-functions such as heat preservation, freezing preservation, heat insulation, waterproofing, damp-proofing, fire prevention, exfoliation prevention, sound insulation, blooming prevention, air purifying, sterilization, and anion generating.

### DETAILED DESCRIPTION OF INVENTION

Multifunctional composite building materials according to the present invention are typical inorganic materials and obtained by mixing nano materials such as nano silicon dioxide, nano titanium dioxide, nano aluminum oxide and nano zinc oxide with nano nickel-cobalt ferrite or nano nickel-zinc ferrite; surface active agent; air entrained agent such as diethanolamine lauryl sulphonate, protein extracts, pulp waste liquid, diatomite; “Kumgang” medical stone; viscosifier such as hydroxy ethyl cellulose (HEC) and foam elimination agent such as tributylphosphoric acid ester or butanol in a certain ratio.

The mixing proportion of compositions is 30˜40% of nano materials such as nano silicon dioxide, nano titanium dioxide, nano aluminum oxide and nano zinc oxide; 15˜30% of nano nickel-cobalt ferrite or nano nickel-zinc ferrite; 2˜5% of surface active agent; 5˜10% of air entrained agent such as diethanolamine lauryl sulphonate, protein extracts, pulp waste liquid, diatomite; 15˜25% of “Kumgang” medical stone; 1˜2% of viscosifier such as hydroxy ethyl cellulose (HEC) and 1˜2% of foam elimination agent such as tributylphosphoric acid ester or butanol.

Nano silicon dioxide, nano titanium dioxide, nano aluminum oxide and nano zinc oxide are nano materials in molecular state, which are obtained by chemical method and are full of micro pores.

As particle size of nano materials is 1/100 of wave length of the infrared rays and energy of the infrared rays is large than kinetic energy of nano materials, the nano materials have very strong infrared absorptiveness.

In relation to ultraviolet rays, as electromagnetic wave energy of the ultraviolet rays does not move nano materials, nano materials have ultraviolet reflectance characteristic, thereby having adiabatic characteristic and ultraviolet shield characteristic, and the heat conductivity coefficient is 0.015˜0.022w/mk.

Ferrite forms electrode without external electric field and is not affected by air temperature and moistness, and is not decreased, thereby producing a long term anion generating and air purifying effects, and the number of anion per cm³ is over 590.

Triethanolamine as a surface active agent is a transparent viscous liquid which operates to disperse nano materials and operates as a hardening and accelerating agent by mixing with cement.

Diethanolamine lauryl sulphonate is an air entrained agent and when mixing with cement, forms micro blisters to improve workability.

The preferred embodiment of multifunctional composite building materials according to the present invention is shown below.

Embodiment: Composition of multifunctional composite building materials is as follows:

10% of nano zinc oxide,

10% of nano titanium dioxide,

10% of nano silicon dioxide,

10% of nano aluminum oxide,

25% of nano nickel zinc ferrite,

10% of diethanolamine rauryl sulphonate,

20% of “Kumgang” medical stone,

2% of sodium stearate,

2% of hydroxy ethyl cellulose (HEC), and

1% of tributylphosphoric acid ester or butanol.

The above multifunctional composite building materials have various functions such as heat preservation, freezing preservation, heat insulation, waterproofing, damp-proofing, fire prevention, exfoliation prevention, sound insulation, blooming prevention, air purifying, sterilization and anion generating, etc.

The above multifunctional composite building materials are building materials which are not subject to the influence of seasons or temperatures and can construct in all seasons irrespective of dry or wet construction method.

Also, as the building structures are not subject to the influence of coldness, hotness or moisture, the life of building structures is lengthened more than 3 times.

As the above multifunctional composite building materials consist of nano materials, the water permeability on the concrete plastered surface is low, thereby saving 50% of various coating materials including indoor paint and outdoor paint.

The present invention further discloses the construction method of the above multifunctional composite building materials.

The present invention provides the construction method of single coating the multifunctional composite building materials in place of various construction processes in the finishing works of building structures.

Building structures, after completing concrete structure work (construction of foundation wall and framing of buildings), are completed through various construction processes such as waterproofing process, dump-proofing process, adhering construction of heat insulating materials or expanded plastics, construction of wire mesh or galvanized fabric, dilatation, fixing of dead bolt, secondary plastering, putty plastering, abrasive process, coating with primer for indoor paint or outdoor paint, and so on.

The present invention provides the construction method of single coating concrete or cement mortar plastered layer of the inside and outside of buildings with the mixture of the said multifunctional composite building materials and vehicle, thereby reducing the above mentioned construction processes.

In coating, 30˜40% of the multifunctional composite building materials are mixed with 60˜70% of the vehicle, and the mixture is used.

The vehicle, according to objects to be constructed, is aqueous vehicle such as indoor paint, outdoor paint, waterproofing material, inorganic coating materials, latex, polyvinyl or acryl resin; or oil vehicle such as penta resin, glybutal resin, silicon resin, fluoro resin or epoxy resin, etc.

The construction method according to the invention can increase the working speed more than 5 times and reduce a lot of materials, fund and labor.

The following is the construction method of the above multifunctional composite building materials.

First, the ground surface to be constructed is cleaned and wetted fully with water.

Then, the multifunctional composite building materials are mixed with the vehicle in the ratio of 7:3 or 6:4 according to objects to be constructed, and the said obtained materials are further mixed evenly with cement and water in the ratio of 1:3:5 to make the first mixture. And, the above obtained materials are mixed evenly with cement and water in the ratio of 1˜1.5:3:4 to make the second mixture.

Then, the ground surface wetted fully with water is sprayed or coated with the first mixture by sprayer or brush, etc 2˜3 times over in case of the outside, 1˜2 times in case of the inside.

The surface is plastered with the second mixture so that the thickness is over 0.5 min.

Water is often sprinkled on the plastered surface 4˜6 hours after finishing construction so that the surface is not gotten half-dried and is wet cured.

In this way, nano membrane is formed on the surface of concrete or mortar layer and insoluble hydrated product is formed in the inside, thereby forming the layer with the functions such as heat preservation, freezing preservation, heat insulation, waterproofing, damp-proofing, fire prevention, exfoliation prevention, sound insulation, blooming prevention, air purifying, sterilization and anion generating, which is full of micropores.

The above multifunctional composite building materials can be applied to all the building structures such as house, public buildings, tall buildings, underground structures, various large freezing facilities, heating facilities, tunnel, canal tunnel, roadway tunnel or road facilities network, etc.

1. Multifunctional composite building materials with functions such as heat preservation, freezing preservation, heat insulation, waterproofing, damp-proofing, fire prevention, exfoliation prevention, sound insulation, blooming prevention, air purifying, sterilization and anion generating, comprising:
30-40% of nano materials such as nano silicon dioxide, nano titanium dioxide, nano aluminum oxide and nano zinc oxide;
15-30% of nano nickel-cobalt ferrite or nano nickel-zinc ferrite;
2-5% of surface active agent;
5-10% of air entrained agent;
15-25% of “Kumgang” medical stone;
1-2% of viscosifier; and
1-2% of foam elimination agent.

2. The multifunctional composite building materials according to claim 1, wherein the surface active agent is amine acid system surface active agent.

3. The multifunctional composite building materials according to claim 1, wherein the air entrained agent includes at least one of diethanolamine lauryl sulphonate, protein extracts, pulp waste liquid and diatomite.

4. The multifunctional composite building materials according to claim 1, wherein the viscosifier is hydroxyl ethyl cellulose (HEC), and the foam elimination agent is tributylphosphoric acid ester or butanol.

5. A construction method of single coating the multifunctional composite building materials according to claim 1 in place of various construction processes which are necessary for finishing work of building structures.

6. The construction method of multifunctional composite building materials according to claim 5, wherein 30-40% of multifunctional composite building materials are mixed with 60-70% of vehicle and the mixture is directly coated on a concrete or cement mortar plastered layer of an inside or outside of the building structures.

7. The construction method of multifunctional composite building materials according to claim 6, wherein the vehicle, according to objects to be constructed, is aqueous vehicle such as indoor paint, outdoor paint, waterproofing material, inorganic coating materials, latex, polyvinyl or acryl resin; or oil vehicle such as penta resin, glybutal resin, silicon resin, fluoro resin or epoxy resin.

8. A construction method of multifunctional composite building materials according to claim 1, which consist of the following steps:
a) cleaning a ground surface to be constructed and wetting the ground surface with water;
b) mixing the multifunctional composite building materials and the vehicle in a ratio of 7:3 or 6:4 according to objects to be constructed;
c) making a first mixture by mixing the above mixed materials, cement and water in a ratio of 1:3:5, and a second mixture by mixing the above mixed materials, cement and water in a ratio of 1-1.5:3:5;
d) spraying or coating the first mixture on the ground surface wetted with water by sprayer or brush 2-3 times in case of an outside application, and 1-2 times in case of an inside application;
e) plastering the ground surface with the second mixture at a thickness of at least 0.5 mm; and
f) wet curing the plastered ground surface by sprinkling water 4-6 hours after finishing construction.

9. Building structures having the multifunctional composite building materials according to claim 1 applied thereon the building structures including a house, public buildings, tall buildings, underground structures, various large freezing facilities, heating facilities, tunnel, canal tunnel, roadway tunnel or road facilities network.

10. The multifunctional composite building materials according to claim 1, wherein the surface active agent is triethanolamine or sodium stearate.
